(19) United States
(12) Patent Application Publication
(10) Pub. No.: US 2025/0066198 A1
(43) Pub. Date: Feb. 27, 2025

(54) DRY DISPERSION OF AMMONIUM BIS(FLUOROSULFONYL)IMIDE (NH4FSI) SALT WITH AN AT LEAST BIMODAL PARTICLE SIZE DISTRIBUTION

(71) Applicant: SPECIALTY OPERATIONS FRANCE, Lyon (FR)

(72) Inventor: Joo-Hee Kang, Lyon (FR)

(73) Assignee: SPECIALTY OPERATIONS FRANCE, Lyon (FR)

(21) Appl. No.: 18/711,492

(22) PCT Filed: Nov. 18, 2022
(86) PCT No.: PCT/EP2022/082382

§ 371 Date: May 17, 2024

(30) Foreign Application Priority Data
Nov. 19, 2021 (EP) 21315245.7

(51) Int. Cl. C01B 21/086

(52) U.S. Cl. CPC C01B 21/086; C01P 2004/53

(57) ABSTRACT

The present disclosure relates to a dry dispersion of ammonium bis(fluorosulfonyl)imide (NH₄FSI) salt of formula (I): [F—SO₂—N⁻—SO₂—F], NH₄⁺ (I) characterized by having at least two particle size fractions, i.e. a small-size fraction and a large-size fraction. The present disclosure also relates to the use of such dispersion to prepare a salt of bis(fluorosulfonyl)imide selected from the group consisting of a lithium slat, a sodium salt or a potassium salt.

### CROSS-REFERENCE TO RELATED PATENT APPLICATIONS

This patent application claims priority filed on 19 Nov. 2021 in EUROPE with Nr. 21315245.7, the whole content of this application being incorporated herein by reference for all purposes.

### TECHNICAL FIELD

The present disclosure relates to dry dispersion of ammonium bis(fluorosulfonyl)imide (NH₄FSI) salt of formula (I):

[F—SO₂—N⁻—SO₂—F],NH₄⁺ (I)
characterized by having at least two particle size fractions, i.e. a small-size fraction and a large-size fraction. The present disclosure also relates to the use of such dispersion to prepare a salt of bis(fluorosulfonyl)imide selected from the group consisting of a lithium slat, a sodium salt or a potassium salt.

### BACKGROUND

Bis(fluorosulfonyl)imide and salts thereof, in particular the lithium salt of bis(fluorosulfonyl)imide (LiFSI), are useful compounds in a variety of technical fields, notably for battery electrolytes.

The production of bis(fluorosulfonyl)imide (FSI) and salts thereof is described in the literature. One of the possible intermediates leading to FSI salts of interest is ammonium bis(fluorosulfonyl)imide (NH₄FSI). For example, WO 2017/090877 A1 (CLS) describes a method for producing lithium bis(fluorosulfonyl)imide comprising the steps of: (1) reacting bis(chlorosulfonyl)imide with a fluorinating reagent in a solvent, followed by treatment with an alkaline reagent, thereby producing NH₄FSI; and (2) reacting the NH₄FSI with a lithium base.

Because intermediates, such as NH₄FSI salts, are engaged into further manufacturing steps and sometimes need to be moved from one area of the plant to another, it is convenient to have them in form of dry dispersions or powders.

WO 2018/147195 A1 (Morita & Nippon Shokubai) relates to dry powders of bis (fluorosulfonyl) imide metal salt having a particle diameter of not less than 0.2 mm. It also relates to methods for preparing such powders comprising shaping the salt in molten state. The powders are heated and melted to be in molten state, and then shaped using any available method, including dry processes and wet processes (drum flake granulation method, casting method, roll-drop steel belt granulation method, prilling tower granulation method, melt crystallisation . . . ).

US 2016/0289074 A1 (Nippon Soda) relates to granules or powders of a di(sulfonylamide) salt, such as a di(sulfonylamide) alkali metal salt or a di(sulfonylamide) ammonium salt. The granules or powders in this document consist of a compound of formula [I]:

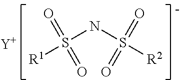

wherein R¹ and R² each independently represents a fluoroalkyl group having 1 to 6 carbon atoms, or a fluorine atom, and Y⁺ represents an alkali metal cation or an ammonium cation, wherein the granules have a modal diameter of less than 80 μm and a median diameter of less than 45 μm, for example between 5 and 45 μm.

US 2019/0276311 A1 (Nippon Shokubai) relates to a method for producing a FSI metal salt, comprising the reaction of bis(fluorosulfonyl)imide (HFSI) with an alkali metal halide in a reaction solution including an organic solvent, and a purification step by filtration of the FSI salt obtained therefrom. The filtering is preferably performed by using a filter medium having retained particle diameter of 0.1 to 10 μm.

None of these documents describe the NH₄FSI salts dispersions of the present invention, having at least two particle size fractions, and therefore a flowability and a dissolution into various solvents which make them well-suited to be stocked and engaged into further manufacturing processes.

### SUMMARY

The present invention relates to a dry dispersion of ammonium bis(fluorosulfonyl)imide (NH₄FSI) salt of formula (I):

[F—SO₂—N⁻—SO₂—F],NH₄⁺ (I)
wherein the NH₄FSI salt is possibly in a form of a solvate comprising:
   50 to 99.9 wt. %, of the NH₄FSI salt, and
   0.1 to 50 wt. %, of solvent S₂, which is selected from the group consisting of cyclic and acyclic ethers,
wherein the dry dispersion comprises at least two particle size fractions, i.e. a small-size fraction and a large-size fraction.

The present invention also relates to a process for preparing a bis(fluorosulfonyl)imide (MFSI) salt of formula (II):

[F—SO₂—N⁻—SO₂—F],M⁺ (II)
wherein M is selected from the group consisting of Li, Na and K,
wherein the process comprises reacting the dry dispersion of ammonium bis(fluorosulfonyl)imide (NH₄FSI) salt of formula (I) described herein with a compound (C) selected from the group consisting of lithium compounds, sodium compounds and potassium compounds.

Another aspect of the present invention is the dry dispersion of bis(fluorosulfonyl)imide (MFSI) salt of formula (II):

[F—SO₂—N⁻—SO₂—F],M⁺ (II)
wherein M is selected from the group consisting of Li, Na and K, and comprises at least two particle size fractions. Such dispersion may be obtained from the process described herein.

### DISCLOSURE OF THE INVENTION

In the present application
any description, even though described in relation to a specific embodiment, is applicable to and interchangeable with other embodiments of the present invention;
where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components; any element or component recited in a list of elements or components may be omitted from such list; and
any recitation herein of numerical ranges by endpoints includes all numbers subsumed within the recited ranges as well as the endpoints of the range and equivalents.

The dry dispersion of ammonium bis(fluorosulfonyl)imide (NH₄FSI) salt of the present invention is characterized in that it comprises at least two particle size fractions, i.e. a small-size fraction and a large-size fraction. The dispersion of the present invention may comprise more than two fractions. Preferably, the dispersion of the present invention is characterized by a bimodal particle size distribution. The fractions may be characterized by various Particle Size Distribution (PSD) parameters, for example their d₅₀-value. Also called D50, the d₅₀-value is known as the median diameter or the medium value of the PSD. It is the value of the particle diameter at 50% in the cumulative distribution. It means that 50 vol. % of the particles in the sample are larger than the d₅₀-value, and that 50 vol. % of the particles in the sample are smaller than the d₅₀-value.

In some preferred embodiments, the small-size fraction has a d₅₀-value of less than 120 μm, for example less than 115 μm, less than 110 μm, less than 105 μm or even less than 100 μm, as determined by laser diffraction in n-hexane.

The small-size fraction may also be such that:
its d₁₀-value is not less than 20 μm, preferably between 30 and 100 μm, more preferably between 40 and 95 μm, even more preferably between 60 and 90 μm; and/or
its d₅₀-value is between 80 and 115 μm, preferably between 85 and 110 μm, more preferably between 90 and 105 μm.

In some other preferred embodiments, the large-size fraction has a d₅₀-value of more than 200 μm, more than 210 μm, more than 220 μm or even more than 230 μm, as determined by laser diffraction in n-hexane.

The large-size fraction may also be such that:
its d₅₀-value is between 200 and 250 μm, preferably between 205 and 245 μm, more preferably between 210 and 240 μm;
its d₉₀-value is between 260 and 300 μm, preferably between 265 and 290 μm, more preferably between 275 and 285 μm; and/or
its d₉₉-value is between 300 and 400 μm, preferably between 310 and 380 μm.

The volume ratio of the small particles to the large particles may be from 5:95 to 95:5, from 10:90 to 90:10 or from 20:80 to 80:20. The volume ratio may be determined by software calculations, for example using SYMPATEC®.

The PSD of the dry dispersion of the present invention may preferably be such that:
its d₁₀-value is not less than 20 μm, preferably between 30 and 100 μm, more preferably between 40 and 95 μm, even more preferably between 60 and 90 μm;
its d₅₀-value is between 140 and 190 μm, preferably between 145 and 185 μm, more preferably between 150 and 180 μm;
its d₉₀-value is between 260 and 300 μm, preferably between 265 and 290 μm, more preferably between 275 and 285 μm; and/or
its d₉₉-value is between 300 and 400 μm, preferably between 310 and 380 μm, as determined by laser diffraction in n-hexane.

In some embodiments, the aspect ratio defined as the average ratio of Feret's minimum length to the Feret's maximum length, as counted on about 60 particles from a scanning electron microscopy (SEM) image) of the dry dispersion ranges between 0.3 and 1.0, preferably between 0.5 and 0.95, even more preferably between 0.7 and 0.9.

The small-size and large-size fractions of the present invention may also be characterized by their particle diameter Dp at the peak of the volume-based particle size distribution.

In some embodiments, the particle diameter Dp at the peak of the small-size fraction is between 80 and 115 μm, preferably between 85 and 110 μm, more preferably between 90 and 105 μm.

In some embodiments, the particle diameter Dp at the peak of the large-size fraction is between 200 and 250 μm, preferably between 205 and 245 μm, more preferably between 210 and 240 μm.

The dispersion of the present invention may be such that it has a shape being at least one selected from the group consisting of a quadrilateral-like shape, a monoclinic-like shape, a sphere-like shape, a rod-like shape, a needle-like shape and mixtures thereof. Preferably, it has a shape being at least two selected from the group consisting of a quadrilateral-like shape, a monoclinic-like shape, a sphere-like shape, a rod-like shape, a needle-like shape and mixtures thereof.

In some embodiments, the dispersion has a shape such that:
a small fraction Fₛ is a rod-like shape and/or a needle-like shape; and
a large fraction F_{L} is a quadrilateral-like shape, a monoclinic-like shape and/or a sphere-like shape, wherein the small fraction is less than 50 wt. % and the large fraction is more than 50 wt. %, the sum of Fₛ+F_{L} being equal to 100 wt. %.

In some embodiments, the NH₄FSI salt in the dispersion is in a form of a solvate, possibly in a crystallized form, comprising:
50 to 99.9 wt. %, of the NH₄FSI salt, and
0.1 to 50 wt. %, of solvent S₂, which is selected from the group consisting of cyclic and acyclic ethers.

In some embodiments, the NH₄FSI salt in the dispersion may be a solvate comprising from 50 to 99.5 wt. %, from 50 to 99 wt. %, or from 50 to 98 wt. % of the NH₄FSI salt. The NH₄FSI salt in the dispersion may also be a solvate comprising from 50.5 to 99.9 wt. %, from 51 to 99 wt. %, or from 52 to 98 wt. % of the NH₄FSI salt. The NH₄FSI salt in the dispersion may even be a solvate comprising from 55 to 95 wt. %, from 60 to 90 wt. %, or from 63 to 83 wt. % of the NH₄FSI salt.

In some embodiments, the NH₄FSI salt in the dispersion may be a solvate comprising from 0.1 to 49.5 wt. %, from 0.1 to 49 wt. %, or from 0.1 to 48 wt. % of the solvent S₂. The NH₄FSI salt in the dispersion may also be a solvate comprising from 0.5 to 50 wt. %, from 1 to 50 wt. %, or from 2 to 50 wt. % of the solvent S₂. The NH₄FSI salt in the dispersion may even be a solvate comprising from 5 to 45 wt. %, from 10 to 40 wt. %, or from 17 to 37 wt. % of the solvent S₂.

The dry dispersion of the present invention may be obtained by a process comprising the steps of:
i) providing a crude salt of NH₄FSI;
ii) dissolving the crude salt of NH₄FSI in at least one solvent S₁;
iii) crystallizing the crude salt of NH₄FSI by means of at least one solvent S₂; and
iv) separating the NH₄FSI salt from at least part of the solvents S1 and S₂, preferably by filtration.

The crude salt of NH₄FSI may comprise from 80 to 97 wt. % of the salt of NH₄FSI, preferably from 85 to 95 wt. %, more preferably from 90 to 95 wt. %. The crude salt of NH₄FSI also comprises impurities such as FSO₃⁻, F⁻, ClO⁻, SO₄²⁻, NH₂SO₃⁻, NH₄[N(SO₃H)(SO₂F)] (OFSI), and/or NH₄[N(SO₃H)₂] (OSI).

The weight content of these impurities may vary between 3 and 20 wt. %, for example between 5 and 15 wt. % or between 10 and 5 wt. %.

In some embodiments, the solvent S₁ is selected from the group consisting of acetonitrile, valeronitrile, adiponitrile, benzonitrile, methanol, ethanol, 1-propanol, 2-propanol, 2,2,2,-trifluoroethanol, n-butyl acetate, isopropyl acetate, and mixtures thereof; preferably 2,2,2,-trifluoroethanol (TFE).

In some other embodiments, the solvent S₂ is selected from the group consisting of diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, and 1,4-dioxane, and mixtures thereof; more preferably from the list consisting of diethyl ether, diisopropyl ether, methyl t-butyl ether, 1,2-dimethoxyethane, tetrahydrofuran, 2-methyltetrahydrofuran, dioxane and mixtures thereof; even more preferably being 1,3-dioxane or 1,4-dioxane.

In one preferred embodiment, the dry dispersion is in the form of a solvate, at least partially crystallized, comprising from 0.1 wt. % to 50 wt. % of a solvent S₂ (preferably dioxane) and from 50 to 99.9 wt. % of the NH₄FSI salt, such dispersion being obtained by a process comprising the steps of:
i) providing a crude salt of NH₄FSI;
ii) dissolving the crude salt of NH₄FSI in at least one solvent S₁ (preferably TFE);
iii) crystallizing the crude salt of NH₄FSI by means of at least one solvent S₂ (preferably dioxane); and
iv) separating the NH₄FSI salt from at least part of the solvents S1 and S₂, preferably by filtration.

In some embodiments, the weight ratio of S₁/S₂ in the process from preparing the dispersion of the present invention varies between 1/10 and 10/1, preferably between 1/5 and 5/1, more preferably between 1/2 and 2/1.

The present invention also relates to a process for preparing a bis(fluorosulfonyl)imide (MFSI) salt of formula (II):

[F—SO₂—N⁻—SO₂—F],M⁺ (II)
wherein M is selected from the group consisting of Li, Na and K,
wherein the process comprises reacting the dry dispersion of ammonium bis(fluorosulfonyl)imide (NH₄FSI) salt of formula (I) as described in the present disclosure with a compound (C) selected from the group consisting of lithium compounds, sodium compounds and potassium compounds.

In some embodiments, the compound (C) is a lithium compound, preferably selected from the group consisting of lithium hydroxide LiOH, lithium hydroxide hydrate LiOH·H₂O, lithium carbonate Li₂CO₃, lithium hydrogen carbonate LiHCO₃, lithium chloride LiCl, lithium fluoride LiF, alkoxide compounds such as CH₃OLi and EtOLi, alkyl lithium compounds such as EtLi, BuLi and t-BuLi, lithium acetate CH₃COOLi, and lithium oxalate Li₂C₂O₄, more preferably LiOH·H₂O or Li₂CO₃.

The present invention also relates to a dry dispersion of a bis(fluorosulfonyl)imide (MFSI) salt of formula (II):

[F—SO₂—N⁻—SO₂—F],M⁺ (II)
wherein M is selected from the group consisting of Li, Na and K,
wherein the dry dispersion comprises at least two particle size fractions.

The dry dispersion of MFSI salt may be obtained from the process described above.

The MFSI salt described herein is preferably LiFSI.

In some embodiments, the dry dispersion of MFSI salt contains at least 1 ppm of solvent S₂. The dry dispersion of MFSI salt may for example contain from 1 to 100 ppm of solvent S₂, from 2 to 80 ppm, from 3 to 60 ppm, from 4 to 40 ppm or from 5 to 25 ppm of solvent S₂.

Should the disclosure of any patents, patent applications, and publications which are incorporated herein by reference conflict with the description of the present application to the extent that it may render a term unclear, the present description shall take precedence.

The disclosure will be now described in more detail with reference to the following examples, whose purpose is merely illustrative and not intended to limit the scope of the disclosure.

### EXAMPLES

The PSD of two dispersions of FSI salts were analysed. The first one is a dispersion of NH₄FSI salts according to the present invention (powder #1). The second one is a dispersion of LiFSI salts commercially available as IONEL® from Nippon Shokubai (powder #2).

### Powder #1—Dispersion of a NH₄FSI in the Form of a Solvate

The inventive dispersion was prepared according to the following process:

A 500 mL reactor with stirring means, a double jacket for thermal regulation, a condenser, a pressure regulator means and a liquid or gas addition means was used. 400 g of ethyl methyl carbonate (EMC) were introduced in the reactor at room temperature. 81 g of anhydrous NH₄F was suspended in the reactor. 77 g of molten HCSI was then added gradually during 1 hour, and the mixture was heated at 80° C. under stirring for 15 hours. The reaction mixture was then cooled to room temperature and 25 g of NH₄OH (aq) (ammonia water) was added. The reaction mixture containing NH₄FSI salt was stirred at room temperature for 1 h and then filtered.

332 g of this crude NH₄FSI was concentrated to 48 g. 300 g of 2,2,2-trifluoroethanol (TFE) was added into the solution and concentrated into a 170 g solution; this operation was repeated twice. The 170 g solution was then transferred into the 3-necked flask. Appropriate stirring and temperature were set up to ensure a complete dissolution of NH₄FSI in TFE. Then, 139.5 g of 1,4-dioxane was added dropwise to the reactor in 3 h. After completion of the 1,4-dioxane addition, the solution temperature was kept at 60° C. for another period of 2 h. The mixture was then allowed to cool down to room temperature and stirred overnight. The flask content was then filtrated using a 0.22 μm PTFE membrane to collect the solid NH₄FSI. The collected solid cake was washed with 60 g of 1,4-dioxane. The collected solid was dried using the rotary evaporator under 70° C. at 20 mbar until there was no more solvent evaporation to afford 28.8 g of a white solid. This white solid is a crystallised solvate of NH4FSI (NH₄FSI—S) comprising 80 wt. % of NH₄FSI and 20 wt. % of 1,4-dioxane.

The recrystallization yield, as calculated by the following formula, is 48%.

$$Yield = \frac{weight ( {NH}_{4} FSI in {NH}_{4} FSI - S )}{weight ( Crude {NH}_{4} FSI )}$$

### Test Methods

### PSD

The PSD was determined by laser diffraction method (HELOS CUVETTE). The diffraction information (raw data) was converted to the cumulative distribution as well as the normalized differential distribution by the SYMPATEC® software provided by device manufacturer. The samples, meanwhile, were prepared in the glove box. 0.1 mg of solid sample were dispersed in 2.5 mL of n-hexane to give a final particle mass fraction of about 4%.

### Shape

Particle morphology of solid samples was analyzed by optical microscopy (bright field). The samples were prepared in the glove box. 0.1 mg of solid sample were mixed with paraffin on the slide glass, covered with a cover glass, and then sealed by UV curing.

### Results

### Powder #1

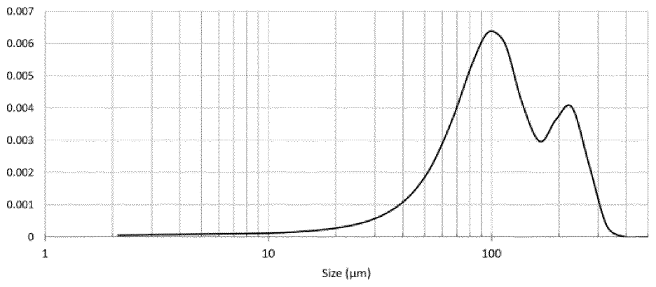

FIG. 1 shows the bimodal particle size distribution (PSD) of the dry dispersion.

| | dispersion | small-size fraction | large-size fraction |
|---|---|---|---|
| d10-value (μm) | 81 | 59 | 157 |
| d50-value (μm) | 164 | 100 | 220 |
| d90-value (μm) | 285 | 141 | 283 |
| d99-value (μm) | 351 | nd | nd |
| particle diameter | nd | 97 | 229 |
| Dp at the peak | | | |
| (μm) | | | |

Volume ratio of the small particles to the large particles: 1/1

The particle morphology was mixed with a majority of quadrilateral-like, monoclinic-like and sphere-like particles, as well as a small portion of rod-like and needle-like shapes.

### Powder #2

| | dispersion |
|---|---|
| d10-value (μm) | 138 |
| d50-value (μm) | 355 |
| d90-value (μm) | 561 |

1. A dry dispersion of ammonium bis(fluorosulfonyl)imide (NH₄FSI) salt of formula (I):
[F—SO₂—N⁻—SO₂—F],NH₄⁺ (I)
wherein the NH₄FSI salt is in a form of a solvate comprising:
50 to 99.9 wt. %, of the NH₄FSI salt, and
0.1 to 50 wt. %, of solvent S₂, which is selected from the group consisting of cyclic and acyclic ethers,
wherein the dry dispersion comprises at least two particle size fractions, a small-size fraction and a large-size fraction.

2. The dispersion of claim 1, wherein:
the small-size fraction has a d₅₀-value of less than 120 μm;
the large-size fraction has a d₅₀-value of more than 200 μm; and/or
the volume ratio of the small particles to the large particles is from 5:95 to 95:5,
as determined by laser diffraction in n-hexane.

3. The dispersion of any of claim 1, wherein the dry dispersion is such that:
its d₁₀-value is not less than 20 μm;
its d₅₀-value is between 140 and 190 μm;
its d₉₀-value is between 260 and 300 μm; and/or
its d₉₉-value is between 300 and 400 μm,
as determined by laser diffraction in n-hexane.

4. The dispersion of claim 1, wherein the small-size fraction of the dry dispersion is such that:
its d₁₀-value is not less than 20 μm, and/or
its d₅₀-value is between 80 and 115 μm,
as determined by laser diffraction in n-hexane.

5. The dispersion of claim 1, wherein the large-fraction of the dry dispersion is such that:
its d₅₀-value is between 200 and 250 μm;
its d₉₀-value is between 260 and 300 μm; and/or
its d₉₉-value is between 300 and 400 μm,
as determined by laser diffraction in n-hexane.

6. The dispersion of claim 1, having a shape being at least one selected from the group consisting of a quadrilateral-like shape, a monoclinic-like shape, a sphere-like shape, a rod-like shape, a needle-like shape and mixtures thereof.

7. The dispersion of claim 6, having a shape being at least two selected from the group consisting of a quadrilateral-like shape, a monoclinic-like shape, a sphere-like shape, a rod-like shape, a needle-like shape and mixtures thereof.

8. The dispersion of claim 6, having a shape such that:
a small fraction Fₛ is a rod-like shape and/or a needle-like shape; and
a large fraction F_{L} is a quadrilateral-like shape, a monoclinic-like shape and/or a sphere-like shape, wherein the small fraction is less than 50 wt. % and the large fraction is more than 50 wt. %, the sum of Fₛ+F_{L} being equal to 100 wt. %.

9. The dispersion of claim 1, wherein the NH₄FSI salt is a solvate comprising a solvent S₂ is selected from the group consisting of diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, and 1,4-dioxane, and mixtures thereof.

10. A process for preparing the dispersion of claim 1, comprising the steps of:
i) providing a crude salt of NH₄FSI;
ii) dissolving the crude salt of NH₄FSI in at least one solvent S₁;
iii) crystallizing the crude salt of NH₄FSI by means of at least one solvent S₂; and
iv) separating the NH₄FSI salt from at least part of the solvents S₁ and S₂, by filtration.

11. The process of claim 10, wherein:
S₁ is selected from the group consisting of acetonitrile, valeronitrile, adiponitrile, benzonitrile, methanol, ethanol, 1-propanol, 2-propanol, 2,2,2,-trifluoroethanol, n-butyl acetate, isopropyl acetate, and mixtures thereof;
S₂ is selected from the group consisting of diethylether, diisopropylether, methyl-t-butylether, dimethoxymethane, 1,2-dimethoxyethane, tetrahydrofuran, 2-methyltetrahydrofuran, 1,3-dioxane, 4-methyl-1,3-dioxane, and 1,4-dioxane, and mixtures thereof; and/or
the weight ratio of S₁/S₂ varies between 1/10 and 10/1.

12. A process for preparing a bis(fluorosulfonyl)imide (MFSI) salt of formula (II):
[F—SO₂—N⁻—SO₂—F],M⁺ (II)
wherein M is selected from the group consisting of Li, Na and K,
wherein the process comprises reacting the dry dispersion of ammonium bis(fluorosulfonyl)imide (NH₄FSI) salt of formula (I) of claim 1 with a compound (C) selected from the group consisting of lithium compounds, sodium compounds and potassium compounds.

13. The process of claim 5, wherein the compound (C) is a lithium compound selected from the group consisting of lithium hydroxide LiOH, lithium hydroxide hydrate LiOH·H₂O, lithium carbonate Li₂CO₃, lithium hydrogen carbonate LiHCO₃, lithium chloride LiCl, lithium fluoride LiF, alkoxide compounds, alkyl lithium compounds, lithium acetate CH₃COOLi, and lithium oxalate Li₂C₂O₄.

14. A dry dispersion of a bis(fluorosulfonyl)imide (MFSI) salt of formula (II):
[F—SO₂—N⁻—SO₂—F],M⁺ (II)
wherein M is selected from the group consisting of Li, Na and K, and
wherein the dry dispersion comprises at least two particle size fractions.

15. The dispersion of claim 14, wherein:
the dispersion contains at least 1 ppm of solvent S₂.
